(19) United States
(12) Patent Application Publication
(10) Pub. No.: US 2004/0146006 A1
(43) Pub. Date: Jul. 29, 2004

(54) System and method for internal network data traffic control

(76) Inventor: Daniel H. Jackson, Plano, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 10/351,469

(22) Filed: Jan. 24, 2003

(51) Int. Cl. H04L 12/26

(52) U.S. Cl. 370/230; 370/468

(57) ABSTRACT

Disclosed are systems and methods which implement network data traffic identification and analysis at a low level in the network to thereby filter and/or prevent undesired data communication sourced therein. Preferred embodiments utilize a network interface of the present invention, having intelligent control logic thereon, to provide tagging of data packets for identification and/or analysis, such as to provide filtering of further transmission of appropriate data packets by a server deployed at the edge of an external network. Additionally or alternatively, a network interface of the present invention may be utilized to prevent communication of data packets, such as by recognizing that a transmission bandwidth threshold is being exceeded and, therefore, disabling transmission of data packets.

### CROSS-REFERENCE TO RELATED APPLICATIONS

The present application is related to co-pending and commonly assigned U.S. patent application Ser. No. 09/572,112 entitled “Intelligent Feedback Loop Process Control System,” filed May 17, 2000, and Ser. No. 09/875,319 entitled “System and Method for Traffic Management Control in a Data Transmission Network,” filed Jul. 6, 2001, the disclosures of which are hereby incorporated herein by reference.

### TECHNICAL FIELD

The invention relates generally to data networks and, more particularly, to providing control of network data traffic.

### BACKGROUND OF THE INVENTION

A network may experience undesired data traffic from a number of sources or due to a number of causes. For example, a network system may be the subject of an attack, such as a result of the Nimba virus or the Code Red virus, causing data packet flooding within the network. Such attacks are often able to penetrate network firewalls or other prophylactic measures and infect systems internal to a protected network. These infected systems may then, under control of the virus or other rogue code, cause undesired data traffic to be sourced from within the network. The attack may be self propagating, such as via the aforementioned undesired data traffic, and therefore cascade to many or all systems within the network. Such an attack may result in both damage to data and operation of network systems as well as a decrease in network performance associated with consumption of the available bandwidth. Similarly, such an attack may result in the transmission of data from within the network to systems outside the network, such as the Internet, thereby disseminating proprietary or other data.

Additionally or alternatively, a network system or user may implement a transmission of data which results in the undesired dissemination of proprietary or otherwise protected data. For example, although having access rights to retrieve and view proprietary information, a user may not be authorized to disseminate such information to other parties, particularly those outside of an entity with which the network system is associated. However, the user may, whether maliciously or innocently, transmit such proprietary data via the network system to an external system, such as via the Internet. Firewalls and other prophylactic measures are typically ineffective at preventing such data transmissions as the user is an authorized user within the network.

Accordingly, a need exists in the art for systems and methods which filter and/or prevent undesired data communication sourced internal to a network.

### BRIEF SUMMARY OF THE INVENTION

The present invention is directed to systems and methods which implement network data traffic identification and analysis at a low level in the network to thereby filter and/or prevent undesired data communication sourced therein. Preferably, data packet identification and/or analysis is implemented at the network physical layer to provide internal network data traffic control which is transparent to network users and systems.

Preferred embodiments utilize a network interface card (NIC) of the present invention, having intelligent control logic thereon, to provide tagging of data packets for identification and/or analysis, such as to filter further transmission of appropriate data packets. Additionally or alternatively, a NIC of the present invention may be utilized to prevent communication of data packets, such as by recognizing that a transmission bandwidth threshold is being exceeded and, therefore, disabling transmission of data packets.

Disabling transmission of data packets according to a preferred embodiment of the present invention is preferably based upon operating parameters provided to intelligence within the NIC. For example, a network management tool may be utilized to provide data transmission bandwidth thresholds to a NIC of the present invention. Thereafter, the NIC may monitor data transmission bandwidth utilized for a comparison to a threshold value which, when exceeded, will result in the NIC shunting or ceasing to transmit some or all data packets.

Control of data packet shunting or ceasing transmission may be controlled by the aforementioned network management tool. For example, the NIC may monitor transmission bandwidth and, when a particular threshold is exceeded, transmit an alarm to the network management tool. The network management tool may provide a control signal to the NIC to cause the shunting of data packets, perhaps after an analysis of various network conditions to determine the propriety of such action.

Tagging of data packets according to a preferred embodiment of the present invention is based upon a classification of the system, e.g., server, sourceing the data packet. For example, a particular server may be classified as storing confidential data, such as by the aforementioned network management tool providing classification information to a NIC thereof, and all data packets emanating from this server may therefore be tagged as confidential. Such tagging may encompass any number of categories or classifications, such as public, private, proprietary, depending upon the level of protection desired with respect to the data. Moreover, such categories and classifications may indicate uses or protocols authorized with respect to the data, such as web transmission, encrypted transmission, etcetera.

Preferably, tagging of data packets is accomplished using techniques which are transparent to the network, its systems and users, and other systems in which the data may be utilized. For example, portions of a data packet header, such as portions of an Internet protocol (IP) data packet header, which are typically unused in routine data transmission may be utilized as flags for tagging data packets according to the present invention.

Preferred embodiments of the present invention utilize a communication channel different than that associated with the general communication functionality of a NIC of the present invention in order to facilitate communication between a network management tool and the NIC even in the event of a data packet flooding event. For example, embodiments of the present invention may utilize a communication channel having some minimum quality of service (QOS) associated therewith to ensure availability of a data connection. A preferred embodiment of the present invention utilizes Internet protocol version 6 (Ipv6) providing a separate channel for Internet security protocol (IPSEC) communications.

It should be appreciated that a technical advantage of the present invention is that systems and methods are provided which filter and/or prevent undesired data communication sourced within in a network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a network system implementing a preferred embodiment of the present invention;

FIG. 2 shows detail with respect to a network interface and management tool adapted according to a preferred embodiment of the present invention;

FIG. 3 shows detail with respect to a detection/notification server adapted according to a preferred embodiment of the present invention; and

FIG. 4 shows a flow diagram of operation according to a preferred embodiment of the present invention.

### DETAILED DESCRIPTION OF THE INVENTION

Directing attention to FIG. 1, system 100 is shown adapted according to an embodiment of the present invention. System 100 includes network systems 120-150 coupled together for information communication via network links, such as may comprise local area network (LAN) links, metropolitan area network (MAN) links, wide area network (WAN) links, public switched telephone network (PSTN) links, wireless links, and/or the like. Network connectivity is provided in the illustrated embodiment by network interface cards 121-151 of network systems 120-150, respectively. Network systems 120-150 may provide various user/network functions such as to provide and manage network mail services (mail server 122 of network system 120), provide and manage network database services (database server 132 of network system 130), provide user terminals (network systems 140 and 150) perhaps having various user application programs operable thereon, such as word-processing, database, e-mail client, network browser, (all not shown), and the like.

Network systems 120-150, router 104, and firewall 103 comprise an “internal” network in that such systems are affiliated or operated for the benefit of a particular entity. As shown in FIG. 1, network systems 120-150 are coupled to external network 101, such as may comprise the Internet, via routers 102 and 104. Firewall 103 is disposed between network systems 120-150 and external network 101 to provide some measure of data protection, as is well known in the art. However, firewall 103 is primarily prophylactic and serves to prevent unauthorized penetration of the internal network systems from systems of external network 101. Although only a single firewall is shown in the illustrated embodiment, it should be appreciated that a number of such devices may be utilized. For example, where one or more of network systems 120-150 are interconnected using a WAN link, such as may utilize public network links of the Internet etcetera, multiple firewalls may be provided to protect each internal network portion defined thereby.

Supplementing the protection provided by firewall 103 is detection/notification server 110 disposed as a network edge device and operable to recognize and prevent attacks on network systems 120-150, such as by flooding, spoofing, and/or the like from systems of external network 101. Detail with respect to these aspects of detection/notification server 110 is provided in the above referenced patent applications entitled “Intelligent Feedback Loop Process Control System” and “System and Method for Traffic Management Control in a Data Transmission Network.”

Similar to firewall 103 discussed above, embodiments of the present invention may utilize a plurality of detection/notification servers, if desired. For example, a number of detection/notification servers may be implemented depending upon network topology, the number of points external networks are coupled to systems of the internal network, the number of external network ports, the volume of network traffic, etcetera.

Additionally or alternatively, detection/notification server 110 is preferably adapted according to the present invention to provide internal network data traffic control. Moreover, NICs, such as one or more of NICs 121-151 are preferably adapted according to the present invention to provide internal network data traffic control. Manager application 152, shown operable upon user terminal network system 150, preferably provides a management console with respect to detection/notification server 110 and/or NICs of the present invention. Accordingly, initialization, monitoring, and/or control of detection/notification server 110 and/or one or more of NICs 121-151 may be provided by manager application 152 to facilitate internal network data traffic control.

Preferably data communication between manager application 152, detection/notification server 110, and/or NICs 121-151 for implementing aspects of the present invention is provided using a channel or channels separate from those utilized to carry the network data. Data communication between manager application 152, detection/notification server 110, and/or NICs 121-151 according to the present invention may be provided using the Internet security protocol (IPSEC) of Internet protocol version 6 (IPv6). Accordingly, data communication between manager application 152, detection/notification sever 110, and/or NICs 121-151 may be provided using a key registration scheme and encoding algorithm. As provided for in IPv6, IPSEC provides a communication channel which, although utilizing the same transmission media as the remainder of the data communications, has at least a minimum quality of service (QOS). Accordingly, data communication is possible between manager application 152, detection/notification server 110, and/or NICs 121-151 even when data communication channels are blocked, such as the result of a flooding attack or other condition resulting in channel bandwidth being substantially fully consumed.

In providing internal network data traffic control according to the present invention, NICs of a preferred embodiment of the present invention include intelligent control logic thereon. For example, NICs of the present invention may include intelligent control logic to provide tagging of data packets for identification and/or analysis, such as to filter further transmission of appropriate data packets. Additionally or alternatively, NICs of the present invention may include intelligent control logic to prevent communication of data packets, such as by recognizing that a transmission bandwidth threshold is being exceeded and, therefore, disabling transmission of data packets.

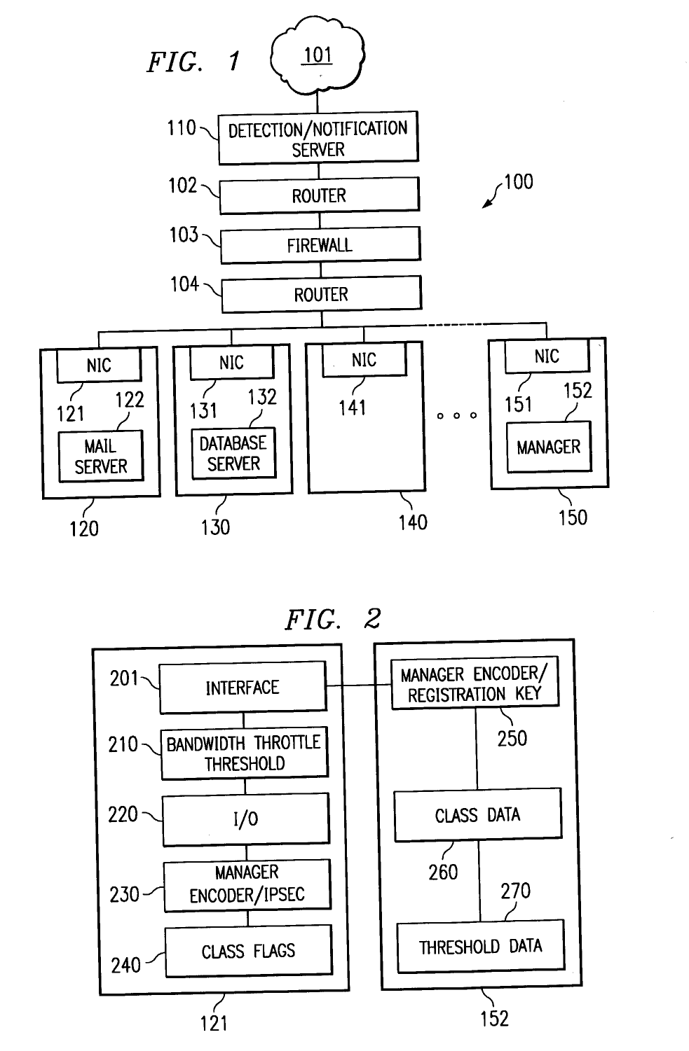

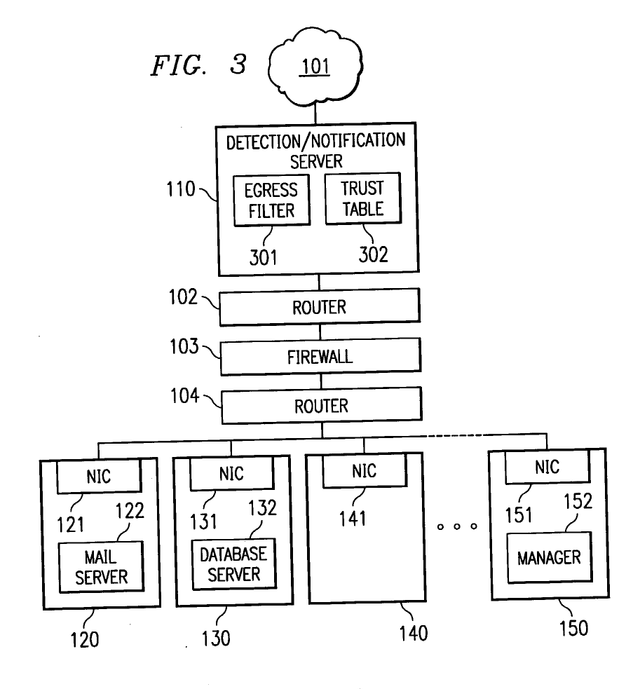

Directing attention to FIG. 2, detail with respect to a preferred embodiment of NIC 121 and manager application 152 is shown. NIC 121 of FIG. 2 is shown to include intelligent control logic of the present invention. Specifically, intelligent control logic of the present invention, including bandwidth throttle threshold 210, manager encoder/IPSEC 230, and class flags 240, are interposed with conventional functional aspects of the NIC, including interface 201 and input/output 220. Manager encoder/IPSEC 230 preferably provides the transport and communication mechanism between NIC 121 and manager application 152. Bandwidth throttle threshold 210 is preferably set by manager application 152 to monitor and/or control use of transmission bandwidth by NIC 121. Class flags 240 is preferably set by manager application 152 for use in tagging data packets transmitted by NIC 121. Interface 201 of the illustrated embodiment provides physical connectivity to a network media, such as a wireless interface, a wireline interface, and/or an optical interface. Input/output 220 provides manipulation of data through the open systems interconnect (OSI) network layers for communication via the physical network.

Manager application 152 is preferably adapted to cooperate with the intelligent control logic of NICs of the present invention to initialize, monitor, and/or control aspects thereof. Accordingly, manager application 152 of the illustrated embodiment includes manager encoder/registration key 250 to facilitate data communication with NIC 121 using IPSEC protocols and corresponding manager encoder/IPSEC 230 of NIC 121. Additionally, manager application 152 of the illustrated embodiment includes class data 260 and threshold data 270 in order to provide NIC 121, e.g., using class flags 240 and bandwidth throttle threshold 210 respectively, with information and/or control for providing tagging of data packets for identification and/or analysis and for preventing communication of data packets.

Preferably, NIC 121 and/or manager application 152 are configured to implement recognition and initialization communication therebetween when NIC 121 is initially deployed in the network and/or upon various reset conditions. Accordingly, an IPSEC channel may be established and various operating instructions and/or parameters may be communicated between NIC 121 and manager application 152 to configure operation according to the present invention in a substantially “plug-and-play” technique.

According to a preferred embodiment of the present invention, internal data communication is monitored to mitigate or prevent over-utilization of communication bandwidth and, therefore, associated communication blockages, network performance degradation, unnecessary network system processing, and/or the like. Such over-utilization of communication bandwidth may be associated with a virus penetrating firewall 103 (FIG. 1) and causing one or more of network systems 120-150 to transmit a large volume of data packets. The problem may be further exacerbated by the virus self propagating such that, where only a few of network systems 120-150 are initially infected, if left unchecked, all of network systems 120-150 may be infected and thus each transmitting a large volume of data packets. Moreover, such over-utilization of communication bandwidth may be associated with more benign causes, such as an authorized user of the network systems unknowingly or accidentally instigating a transmission of data packets sufficient to severely affect network performance. Preferred embodiments of the present invention are adapted to detect excessive utilization of bandwidth within the internal network resulting from a plurality of causes, including those outlined above.

Preferably, the present invention operates to establish a bandwidth threshold or thresholds associated with various network systems and disabling or throttling back transmission of data when a threshold or thresholds are exceeded. Disabling or throttling back transmission of data packets according to the illustrated embodiment is based upon operating parameters provided to bandwidth throttle threshold 210 within the NIC 121. For example, manager application 152 may provide data transmission bandwidth thresholds, such as may be established by and/or stored in threshold data 270, to NIC 121 via an IPSEC channel using manager encoder/registration key 250 and manager encoder/IPSEC 230.

The data transmission bandwidth thresholds of the present invention may be established in a number of ways and may involve various metrics. For example, a data transmission bandwidth threshold may be established which is a ceiling or maximum instantaneous bandwidth allowed or may be a time averaged bandwidth utilization which is acceptable. The data transmission bandwidth thresholds may be established independently for each NIC, for each port (e.g., WEB, FTP, Port 80, etcetera) active on the NIC, for each type of network system, etcetera. For example, a data transmission bandwidth threshold may be established for network systems performing particular services, such as may be based upon an estimate of an expected amount of bandwidth to be typically utilized in performing such services. Additionally or alternatively, a data transmission bandwidth threshold may be established based upon the network configuration, desired performance criteria, QOS metrics, criticality of a particular network system to an enterprise's operation, a trust or security level associated with a particular network system, and/or the like. According to a preferred embodiment, data transmission bandwidth thresholds are established empirically, such as by operation of threshold data 270 of manager application 152, to provide a desired level of operation which takes into consideration the network's configuration and its utilization patterns.

When initially deployed, NIC 121 may not have data transmission bandwidth thresholds established with respect to bandwidth throttle threshold 210. Accordingly, NIC 121 may initially operate without data transmission bandwidth thresholds being implemented. Alternatively, NIC 121 may be provided with “default” value data transmission bandwidth thresholds, such as utilizing the aforementioned plug-and-play technique. Thereafter, NIC 121 and manager application 152 may cooperate to collect data with respect to the operation of NIC 121, network system 120, and/or other network systems to thereby empirically determine desired data transmission bandwidth thresholds to be established with respect to NIC 121. For example, operation of NIC 121 may be monitored for some period of time, e.g., a day, a week, a month, to empirically determine a baseline of network operation with respect to network system 120. This information may be utilized by manager application 152 and/or an operator thereof to establish data transmission bandwidth thresholds for use by NIC 121 according to the present invention. Of course, in addition to or in the alternative to the above mentioned default and empirically determined data transmission bandwidth thresholds, data transmission bandwidth thresholds may be provided in any number of ways including being manually established by a system administrator.

The data transmission bandwidth thresholds, whether manually selected, default values, or empirically determined, are preferably pushed to NIC 121 by manager application 152 using the aforementioned IPSEC channel. Of course, NIC 121 may be initially configured with data transmission bandwidth thresholds, such as at time of manufacture, to facilitate operation without communication with manager application 152, if desired. However, preferred embodiment operation utilizes cooperation between NIC 121 and manager application 152 in establishing data transmission bandwidth thresholds and/or in controlling preventing of communication of data packets, as is further described below, and therefore may utilize the aforementioned data push technique.

According to the illustrated embodiment, the data transmission bandwidth thresholds are provided to bandwidth throttle threshold 210 of NIC 121. Bandwidth throttle threshold 210 of the preferred embodiment monitors bandwidth utilization of the various ports of NIC 121 and compares the utilization information to appropriate ones of the data transmission bandwidth thresholds. Various levels of alarming and other action may be taken based upon the results of such comparisons of the bandwidth utilization and the data transmission bandwidth thresholds. For example, bandwidth throttle threshold 210 may utilize simple network management protocol (SNMP), or another messaging protocol, to communicate an alarm message to manager application 152 in the event a data transmission bandwidth threshold has been exceeded. Additionally or alternatively, bandwidth throttle threshold 210 may take remedial action, such as to disable a particular port of NIC 121 or otherwise shunt data packet transmission, based upon the result of a comparison of bandwidth utilization and the data transmission bandwidth thresholds. According to a preferred embodiment, alarm messages are communicated from NIC 121 to manager application 152 using the aforementioned IPSEC channel to thereby assure that the bandwidth utilization condition does not delay or prevent communication of the alarm to manager application 152.

Manager application 152 may autonomously analyze the alarm condition and direct action, such as to control NIC 121 to disable a particular port or otherwise shunt data packet transmission. Additionally or alternatively, manager application 152 may provide alarm condition information to a system administrator, such as using a display of network system 150 and/or initiating outbound messaging (e.g., via e-mail communication, pager notification, telephonic messaging, and/or the like). Accordingly, a system administrator may be apprised of the situation and take appropriate action, such as to consider the effect of the condition upon other network systems, explore the source of the condition to prevent its escalation, control NIC 121 to disable a particular port or otherwise shunt data packet transmission, alter the rights of a particular user to address the condition, and/or the like.

Preferably data transmission bandwidth thresholds of the present invention are provided in a hierarchical arrangement to facilitate the aforementioned alarm messaging and corrective action. For example, ports of NIC 121 may each have a plurality of data transmission bandwidth thresholds associated therewith. A lowest data transmission bandwidth threshold of each such port may provide for alarm messaging to a system administrator to apprise the system administrator of an increase in bandwidth utilization associated with an associated port. Because this lowest data transmission bandwidth threshold is primarily informational, the alarm message might only be displayed at network system 150 for viewing by a system administrator. A next lowest data transmission bandwidth of each such port may provide an alarm message indicative of impending performance degradation. Because this next lowest data transmission bandwidth threshold is more urgent, the alarm message might cause outbound message notifications to be invoked with respect to one or more system administrators. A highest data transmission bandwidth threshold of each such port may provide for the autonomous deactivation of the associated port, or other shunting of data transmission. For example, bandwidth throttle threshold 210 may determine that this highest threshold has been exceeded and, therefore, disable the associated port of NIC 121, preferably also providing an alarm message to manager application 152 to apprise a system administrator of the situation. Alternatively, bandwidth throttle threshold 210 may determine that this highest threshold has been exceeded, provide an urgent alarm message to manager application 152, and await further instruction with respect to remedial action to be taken.

It may be desirable for bandwidth throttle threshold 210 to provide alarm messaging to manager application 152 and await remedial action instruction for a number of reasons. Manager application 152, through its communication with a plurality of network systems, may be in a position to determine a proper remedial course calculated to minimize the impact upon the operation of the network. For example, manager application 152 may analyze the source of the data packets, the destination of the data packets, and/or the content of the data packets and determine that, although a particular threshold has been exceeded, the data transmission should be allowed to continue. Similarly, manager application 152 may analyze data communication with respect to other network systems and determine that, although a particular threshold has been exceeded; the data transmission should be allowed to continue because the current impact upon network performance is negligible. Manager application 150 may also send control signals to other network systems, such as routers and servers, to reconfigure network operation in light of a particular alarm condition. Additionally, providing alarm messaging to manager application 152 for determinations with respect to appropriate remedial action may be preferred in order to simplify the control logic implemented with respect to bandwidth throttle threshold 210 of NIC 121.

Disabling and enabling of data transmission by NIC 121, and/or particular ports thereof, may be accomplished in a number of ways according to the present invention. For example, bandwidth throttle threshold 210 and/or manager application 152 may provide control signals to input/output 220 to stop input/output functions thereof. Such input/output functions may be stopped for a predetermined amount of time, such as might be based upon the threshold exceeded, the port associated with the threshold, the functionality of the network system associated with the threshold exceeded, etcetera. Alternatively, the input/output functions may be stopped until the occurrence of a particular event, such as a resume control signal being provided from an appropriate one of bandwidth throttle threshold 210 and/or manager application 152 or a reinitialization of NIC 121 and/or network system 120.

Although communication of alarm messages with respect to bandwidth throttle threshold 210 comparing bandwidth utilization to data transmission bandwidth thresholds is discussed above, it should be appreciated that additional or alternative messaging with respect to bandwidth throttle threshold 210 monitoring bandwidth utilization by NIC 121 may be utilized, if desired. For example, bandwidth throttle threshold 210 may periodically provide information with respect to bandwidth utilization to manager application 152 for such purposes as manager application 152 compiling historical data, to set/adjust threshold values or other operational parameters, to map network utilization, etcetera. Similarly, bandwidth throttle threshold 210 may continue to provide information with respect to data provided to input/output 220 by network system 120 after a particular port has been disabled, although a data transmission bandwidth threshold is no longer exceeded due to the associated port being disabled, in order for manager application 152 to determine when a port may again be enabled. For example, manager application 152 may determine that a particular data transmission bandwidth threshold or thresholds would no longer be exceeded and, therefore, provide a control signal to NIC 121 to again enable the affected port.

It should be appreciated that, according to IPv6, IPSEC is an invisible protocol and therefore its associated port is not visible within NIC 121. Accordingly, controlling NIC 121 to disable any or all ports thereof will not result in the disabling of IPSEC communications with respect thereto as only the known IP protocols, e.g., WEB, FTP, Port 80, will be disabled. Subsequently, any or all of these ports may be again enabled using control signals communicated via the aforementioned IPSEC channel.

According to a preferred embodiment of the present invention, internal data communication is monitored to mitigate or prevent undesired communication of data and, therefore, the loss of intellectual property, the dissemination of sensitive data, and/or other unauthorized communication of data. Such unauthorized communication of data may be associated with a virus or other rogue code penetrating firewall 103 (FIG. 1) and causing one or more of network systems 120-150 to transmit data stored thereon to an external system. Moreover, such unauthorized communication of data may be associated with an otherwise authorized user, such as a user of a network system authorized to access data internally transmitting the data to an external system. Preferred embodiments of the present invention are adapted to establish a trust level with respect to systems thereof to intercept unauthorized transmission of data.

Preferably, the present invention operates to tag data packets transmitted by network systems and to dispose a system for analyzing such tagged data packets at a position to analyze and intercept data packets before their communication to external systems. For example, detection/notification server 110 (FIG. 1) may be disposed above edge router 102 and, working in cooperation with manager application 152 and NICs of the present invention, may analyze and intercept particular data packets before their transmission via external network 101. Of course, detection/notification server 110 may be disposed elsewhere in the network, if desired. However, the preferred embodiment disposes detection/notification server 110 as a network edge device as illustrated, at least in part to facilitate implementation of the aforementioned external attack functionality.

Tagging of data packets according to a preferred embodiment of the present invention is based upon a classification of the system, e.g., network system 120, sourcing the data packet. Referring again to FIG. 2, a particular network system may be classified as having a particular type of data associated therewith, such as by manager application 152 providing classification information from class data 260 to class flags 240 of NIC 121. Thereafter, all data packets emanating from this network system may be tagged with the particular classification. Such tagging may encompass any number of categories or classifications, such as public, private, proprietary, depending upon the level of protection desired with respect to the data. Moreover, although described above with respect tagging all data emanating from a particular network system with a same category, embodiments of the present invention may utilizes categories and classifications to indicate uses or protocols authorized with respect to the data, such as web transmission, encrypted transmission, etcetera. Similarly, data packets emanating from particular ports may be tagged using different categories according to the present invention, if desired.

When initially deployed, NIC 121 may not have classification flags established with respect to class flags 240. Accordingly, NIC 121 may initially operate without data packet tagging being implemented. Alternatively, NIC 121 may be provided with “default” value classification flags for use in tagging data packets. Such default classification flags and/or the omission of classification tag information from data packets may preferably result in the prevention of those particular data packets being transmitted to external systems.

NIC 121 and manager application 152 may cooperate to provide desired or appropriate classification flags for subsequent use in tagging data packets. For example, using the above described plug-and-play techniques, appropriate classification flags may be provided to NIC 121 for storage in class flags 240. The classification flags may be established based upon the functionality provided by the network system, the type of data stored upon the network system, the type of user authorized to utilize the network system, input by a system administrator, and/or the like.

The classification flags are preferably pushed to NIC 121 by manager application 152 using the aforementioned IPSEC channel. Of course, NIC 121 may be initially configured with classification flags, such as at time of manufacture, to facilitate operation without communication with manager application 152, if desired. However, preferred embodiment operation utilizes cooperation between NIC 121 and manager application 152 in establishing data transmission bandwidth thresholds and/or in controlling preventing of communication of data packets and therefore may utilize the aforementioned data push technique.

According to the illustrated embodiment, the classification flags are provided to class flags 240 of NIC 121. Class flags 240 of the preferred embodiment cooperates with input/output 220 to tag data packets transmitted by NIC 121 with the appropriate classification. Preferably, tagging of data packets is accomplished using techniques which are transparent to the network, its systems and users, and other systems in which the data may be utilized. For example, a data packet is typically formed by traversing 7 layers of the aforementioned OSI model and will often include both a header portion and a data payload portion. Portions of a data packet header, such as portions of an Internet protocol (IP) data packet header, which are typically unused in routine data transmission may be utilized as flags for tagging data packets according to the present invention. As a data packet is being formed by input/output 220, a desired classification flag as indicated by class flags 240 may be inserted as a single bit or a relatively small number of bits within the header of the packet.

Directing attention to FIG. 3, detail with respect to detection/notification server 110 providing data egress protection according to a preferred embodiment of the present invention is shown. Specifically, detection/notification server 110 includes egress filter 301 and trust table 302 which are preferably utilized in identifying and intercepting particular data packets which are and/or are not authorized for communication to/via external systems. Egress filter 301 and/or trust table 302 may be initialized and/or maintained using manager application 152. For example, manager application 152 may include egress filter and trust table configuration and management functionality to facilitate a system administrator's control and maintenance of these aspects of detection/notification server 110.

Egress filter 301 of the preferred embodiment includes logic for analyzing data packets and processing the data packets in accordance with such analysis. For example, egress filter 301 may analyze header information associated with each data packet to determine a classification flag inserted therein according to a preferred embodiment of the present invention discussed above. Egress filter 301 may utilize information in addition to or in the alternative to the aforementioned classification flag. For example, egress filter 301 may determine a particular network system transmitting data and/or a particular network system intended to receive transmitted data, such as from media access control (MAC) address information. Additionally or alternatively, egress filter 301 may determine a particular type of data being transmitted, such as from the particular port transmitting the data, the data format, and/or the protocol used in transmitting the data. Such information may be utilized by egress filter 301 in determining whether particular data packets should be passed for external transmission. For example, data packets associated with a simple mail transport protocol (SMTP) server may be blocked by detection/notification server 110 because of issues associated with the use of SMTP servers. Similarly, data packets associated with all ports except a WEB port of a particular server may be blocked by detection/notification server 110.

Trust table 302 of the preferred embodiment includes information with respect to trusted sources and/or types of data. For example, trust table 302 may include information with respect to particular classification flags of the present invention to intercept from transmission to external systems and/or to pass for transmission to external systems. Such information may include not only particular classification flags, but may also include particular types of data, ports, network systems, etcetera for any or all such classification flags for which interception and/or transmission to external systems is to be provided. Accordingly, trust table 302 and egress filter 301 of the preferred embodiment cooperate to provide shunting, or other interception, of data packets which are not authorized for transmission to external systems.

In operation according to a preferred embodiment, NIC 121 of network system 120 may be provided a classification flag associated with a “public” classification which is stored in class flags 240. Thereafter, when a user causes data to be transmitted from network system 120 directed to an external system, such as may be coupled to external network 101, the associated data packets tagged with a “public” flag will pass router 104, firewall 103, and router 102 as is conventional. However, the data packets will reach detection/notification server 110 prior to their transmission via external network 101. Preferably, egress filter 301 will analyze the data packets, utilizing information from trust table 302, and determine that the data packets are authorized for “public” distribution and, therefore, allow the data packets to continue via external network 101.

Conversely, in operation according to a preferred embodiment, NIC 131 of network system 130 may be provided a classification flag associated with a “confidential” classification which is stored in class flags logic (not shown) associated therewith. Thereafter, when a user causes data to be transmitted from network system 130 directed to an external system, such as may be coupled to external network 101, the associated data packets tagged with a “confidential” flag will pass router 104, firewall 103, and router 102 as is conventional. However, the data packets will reach detection/notification server 101 prior to their transmission via external network 101. Preferably, egress filter 301 will analyze the data packets, utilizing information from trust table 302, and determine that the data packets are not authorized for “public” distribution and, therefore, will shunt the data packet transmission such that these data packets are not placed upon external network 101.

Preferably, detection/notification server 110 operates to prevent transmission of data to external systems for all data packets except those which are expressly authorized for such transmission. NIC 141 of network system 140, for example, may not be adapted according to the present invention or may not have been initialized to include a classification flag of the present invention. Accordingly, when a user causes data to be transmitted from network system 140 directed to an external system, such as may be coupled to external network 101, the associated untagged data packets will pass router 104, firewall 103, and router 102 as is conventional. However, the data packets will reach detection/notification server 101 prior to their transmission via external network 101. Preferably, egress filter 301 will analyze the data packets, utilizing information from trust table 302, and determine that the data packets, because they are untagged according to the present invention, are not authorized for “public” distribution and, therefore, will shunt the data packet transmission such that these data packets are not placed upon external network 101. Such an embodiment provides for protection of data transmission with NICs adapted according to the present invention deployed only with respect to network systems for which external communication is authorized. Of course, embodiments of the present invention could be adapted for preventing external data transmission with respect to only those network systems having NICs configured according to the present invention, if desired.

It should be appreciated that there are advantages in utilizing classification flags set according to the present invention to identify data authorized/unauthorized for external transmission. For example, although the aforementioned MAC address information uniquely identifies a NIC and, therefore, a network system to which it is coupled, at various points in the network life such NICs may require replacement and/or relocation within the network. Accordingly, utilizing a NIC without control logic of the present invention and relying upon unique information associated therewith, such as MAC address information, requires time consuming and tedious management of MAC tables. However, the classification flags of the present invention are preferably set by manager application 152 and/or a system administrator thereof to indicate the trust level of the network system and/or the data packets associated therewith. Moreover, the preferred embodiment provides for plug-and-play configuration of the control logic of the present invention, further simplifying the maintenance of trust table 302 of the preferred embodiment.

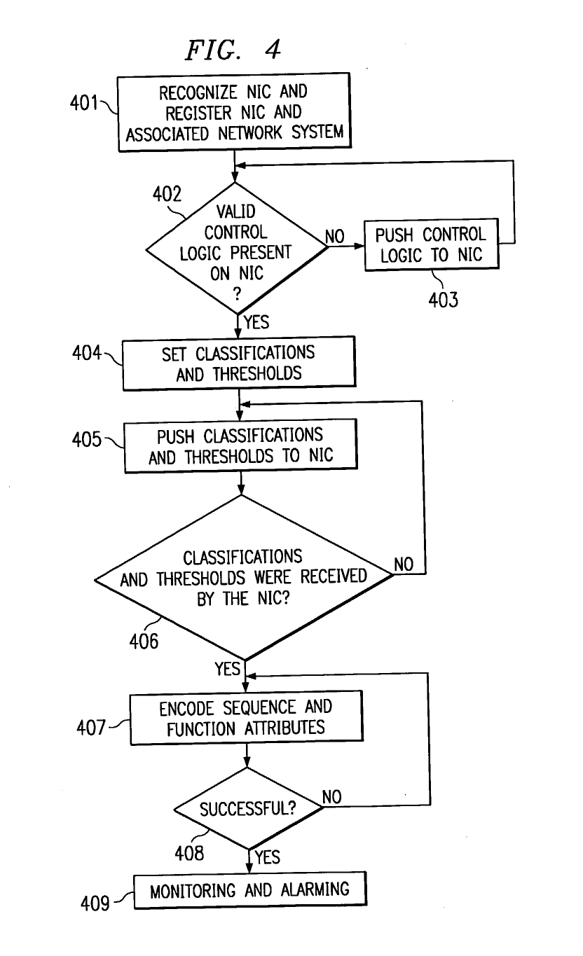

Directing attention to FIG. 4, a flow diagram with respect to operation according to a preferred embodiment of the present invention is shown. At step 401 manager application 152 and/or detection/notification server 110 recognize a NIC of the present invention and operate to register the NIC and its associated network system. At step 402 a determination is made as to whether the recognized NIC has valid/desired control logic present thereon. If the desired control logic is not present on the NIC, step 403 operates to push the desired control logic to the NIC, such as from manager application 152, and processing returns to step 402. However, if the desired control logic is present on the NIC, processing proceeds to step 404. It should be appreciated that steps 401 through 403 may be implemented as part of the aforementioned plug-and-play initialization technique.

At step 404 classification flags and data transmission bandwidth thresholds of the present invention are set. The classification flags and/or data transmission bandwidth thresholds may be set, for example, by a system administrator inputting the appropriate values into manager application 152, by manager application 152 retrieving default or preselected values from a database associated therewith, and/or by manager application 152 analyzing information with respect to operation of the network and establishing appropriate values. The classification flags and data transmission bandwidth thresholds are pushed to the NIC at step 405. Thereafter, at step 406, a determination is made as to whether the classification flags and the data transmission bandwidth thresholds were received by the NIC. If the classification flags and data transmission bandwidth thresholds were not received by the NIC, processing returns to step 405. However, if the classification flags and data transmission bandwidth thresholds were received by the NIC processing continues to step 407. It should be appreciated that steps 404 through 406, or an iteration thereof, may be implemented as a part of the aforementioned plug-and-play techniques. For example, where default or preselected values for the classification flags and data transmission bandwidth thresholds are used, steps 404 through 406 may be implemented as a part of the aforementioned plug-and-play technique. Thereafter, these values may be updated manually or automatically, as desired.

At step 407 the NIC operates to encode the sequence and function attributes to implement the control logic and associated parameters of the present invention. At step 408 a determination is made as to whether the encoding of sequence and function attributes was successful. If the encoding of sequence and function attributes was not successful, processing returns to step 407. However, if the encoding of sequence and function attributes was successful, processing proceeds to step 409. As with the steps discussed above, steps 407 and 408 of the illustrated embodiment may be implemented as part of the aforementioned plug-and-play technique.

At step 409, operation of the NIC to provide internal network data traffic control according to the present invention is instigated in accordance with the control logic and parameters provided thereto. For example, the NIC may monitor bandwidth utilization and provide alarm and/or other messages in response thereto. Additionally, the NIC may provide tagging of data packets transmitted thereby.

It should be appreciated that the control logic of the present invention described herein may be implemented as instruction sets operable with respect to a corresponding processing unit. For example, the above described egress filter and trust table of the detection/notification server may be implemented as software operable upon a microprocessor-based computer system, such as a computer system operable upon the INTEL PENTIUM processor platform. Similarly, the manager application of the network system described herein may be implemented as software operable upon a microprocessor-based computer system. Preferably, NIC control logic, such as the bandwidth throttle threshold, class flags, and encoder described herein, is implemented in non-volatile memory of a host NIC, such as erasable programmable read only memory (EPROM), and is operable with respect to a microprocessor associated therewith. For example, control logic of the present invention may be implemented in the basic input/output system (BIOS) of a NIC. Additionally or alternatively, control logic of the present invention and/or other aspects thereof may be implemented in dedicated purpose devices, e.g., an integrated circuit such as an application specific integrated circuit (ASIC).

Although a preferred embodiment of the present invention has been described herein with respect to providing internal network data traffic control, it should be appreciated that aspects of the present invention are applicable to other network configurations. Accordingly, the present invention is not limited to use with respect to an internal network and, therefore, aspects thereof may be applied to external network systems.

Similarly, although a preferred embodiment of the present invention has been described herein with respect to controlling the transmission of data, it should be appreciated that aspects of the present invention are applicable to other aspects of data communication. For example, aspects of the present invention may be applied to receiving data packets.

Although a preferred embodiment has been described herein with respect to adapting NICs according to the present invention, it should be appreciated that the present invention is not limited to the use of network interfaces commonly thought of as network interface cards. For example, the concepts of the present invention may be applied to network interfaces which are integral to a system and, therefore, not disposed upon a “card.” Similarly, the concepts of the present invention are applicable to integrated circuit embodiments of a network interface.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for controlling network data traffic, said system comprising:
a network interface having control logic thereon for monitoring communication bandwidth utilization associated with said network interface and for decreasing communication of data associated with said network interface as a function of said monitored communication bandwidth utilization.

2. The system of claim 1, wherein said control logic comprises at least one data communication bandwidth threshold value.

3. The system of claim 2, wherein said at least one data communication bandwidth threshold value is associated with a particular port of said network interface.

4. The system of claim 2, wherein said at least one data communication bandwidth threshold value is established as a function of a network service provided by a host system of said network interface.

5. The system of claim 2, wherein said at least one data communication bandwidth threshold value is established empirically as a function of normal operation of a host system of said network interface.

6. The system of claim 2, wherein said control logic issues an alarm message to a separate management console when said monitored communication bandwidth utilization exceeds said at least one data communication bandwidth threshold value.

7. The system of claim 6, wherein said alarm message is communicated to said management console via a communication channel separate from that of said monitored communication bandwidth utilization.

8. The system of claim 7, wherein said communication channel comprises an Internet security protocol channel.

9. The system of claim 6, wherein said control logic decreasing said communication of data associated with said network interface is under control of a control signal provided by said management console responsive to said alarm message.

10. The system of claim 9, wherein said control signal is communicated to said network interface via a communication channel separate from that of said monitored communication bandwidth utilization.

11. The system of claim 10, wherein said communication channel comprises an Internet security protocol channel.

12. The system of claim 2, wherein said control logic decreasing said communication of data associated with said network interface is under autonomous control of said control logic.

13. The system of claim 1, wherein said control logic comprises a hierarchy of data communication bandwidth threshold values.

14. The system of claim 13, wherein said control logic issues an alarm message to a separate management console when said monitored communication bandwidth utilization exceeds said a first data communication bandwidth threshold value of said hierarchy of data communication bandwidth threshold values, and wherein said control logic autonomously decreases said communication of data associated with said network interface when said monitored communication bandwidth utilization exceeds a second data communication bandwidth threshold value of said hierarchy of data communication bandwidth threshold values.

15. The system of claim 1, wherein said control logic decreasing said communication of data associated with said network interface comprises disabling an input/output function of said network interface.

16. The system of claim 1, wherein said control logic decreasing said communication of data associated with said network interface comprises disabling a particular port of said network interface.

17. The system of claim 1, wherein said network interface further has control logic thereon for tagging data communicated thereby with a preselected classification.

18. The system of claim 17, wherein all data transmitted by a host system associated with said network interface is tagged with the same said preselected classification.

19. The system of claim 17, wherein said preselected classification indicates a level of trust associated with a host system of said network interface.

20. The system of claim 17, wherein said preselected classification indicates a level of protection to be afforded said data.

21. The system of claim 17, wherein said preselected classification is associated with a particular port of said network interface.

22. The system of claim 17, wherein said tagging said data comprises inserting a classification flag into a header block of a data packet associated with said data.

23. The system of claim 17, further comprising:
a data filter operable to analyze said data for said classification and to allow or prevent further transmission of said data based upon said classification.

24. The system of claim 23, wherein said data filter is disposed at a network edge.

25. The system of claim 23, wherein said data filter utilizes trust information in determining whether to allow or prevent said further transmission of said data based upon said classification.

26. A system for controlling network data traffic, said system comprising:
a network interface having control logic thereon for tagging data communicated thereby with a preselected classification; and
a data filter operable to analyze said data for said classification and to allow or prevent further transmission of said data based upon said classification.

27. The system of claim 26, wherein all data transmitted by a host system associated with said network interface is tagged with the same said preselected classification.

28. The system of claim 26, wherein said preselected classification indicates a level of trust associated with a host system of said network interface.

29. The system of claim 26, wherein said preselected classification indicates a level of protection to be afforded said data.

30. The system of claim 26, wherein said preselected classification is associated with a particular port of said network interface.

31. The system of claim 26, wherein said tagging said data comprises inserting a classification flag into a header block of a data packet associated with said data.

32. The system of claim 26, wherein said data filter is disposed at a network edge.

33. The system of claim 26, wherein said data filter utilizes trust information in determining whether to allow or prevent said further transmission of said data based upon said classification.

34. The system of claim 26, wherein said control logic and said data filter receive control signals from a separate control console.

35. The system of claim 34, wherein said control signals are communicated via a communication channel separate from that utilized in transmitting said tagged data.

36. The system of claim 35, wherein said communication channel comprises an Internet security protocol channel.

37. The system of claim 26, wherein said network interface further has control logic thereon for monitoring communication bandwidth utilization associated with said network interface and for decreasing communication of data associated with said network interface as a function of said monitored communication bandwidth utilization.

38. The system of claim 37, wherein said control logic comprises at least one data communication bandwidth threshold value.

39. The system of claim 38, wherein said control logic issues an alarm message to a separate management console when said monitored communication bandwidth utilization exceeds said at least one data communication bandwidth threshold value.

40. The system of claim 39, wherein said control logic decreasing said communication of data associated with said network interface is under control of a control signal provided by said management console responsive to said alarm message.

41. The system of claim 38, wherein said control logic decreasing said communication of data associated with said network interface is under autonomous control of said control logic.

42. The system of claim 37, wherein said control logic comprises a hierarchy of data communication bandwidth threshold values.

43. The system of claim 42, wherein said control logic issues an alarm message to a separate management console when said monitored communication bandwidth utilization exceeds said a first data communication bandwidth threshold value of said hierarchy of data communication bandwidth threshold values, and wherein said control logic autonomously decreases said communication of data associated with said network interface when said monitored communication bandwidth utilization exceeds a second data communication bandwidth threshold value of said hierarchy of data communication bandwidth threshold values.

44. The system of claim 37, wherein said control logic decreasing said communication of data associated with said network interface comprises disabling an input/output function of said network interface.

45. The system of claim 37, wherein said control logic decreasing said communication of data associated with said network interface comprises disabling a particular port of said network interface.

46. A method for controlling network data traffic, said method comprising:
monitoring communication bandwidth utilization associated with a network interface, wherein said monitoring is provided by control logic of said network interface; and
decreasing communication of data associated with said network interface as a function of said monitored communication bandwidth utilization.

47. The method of claim 46, further comprising:
providing said control logic with at least one data communication bandwidth threshold value for comparison to said monitored communication bandwidth utilization.

48. The method of claim 47, further comprising:
issuing an alarm message to a separate management console when said monitored communication bandwidth utilization exceeds said at least one data communication bandwidth threshold value.

49. The method of claim 48, wherein said decreasing said communication of data associated with said network interface is under control of a control signal provided by said management console responsive to said alarm message.

50. The method of claim 47, wherein said decreasing said communication of data associated with said network interface is under autonomous control of said control logic.

51. The method of claim 46, wherein said decreasing said communication of data associated with said network interface comprises:
disabling an input/output function of said network interface.

52. The method of claim 46, wherein said decreasing said communication of data associated with said network interface comprises:
disabling a particular port of said network interface.

53. The method of claim 46, further comprising:
tagging data communicated by said network interface with a preselected classification, wherein said tagging is provided by control logic of said network interface.

54. The method of claim 53, wherein said tagging said data comprises:
inserting a classification flag into a header block of a data packet associated with said data.

55. The method of claim 53 further comprising:
filtering data transmission in response to an analysis of said data for said classification.

56. A method for controlling network data traffic, said method comprising:
tagging data communicated by a network interface with a preselected classification, wherein said tagging is provided by control logic of said network interface;
analyzing said data for said classification, wherein said analyzing is performed at a network node separate from said network interface; and
allowing or preventing further communication of said data based upon said analysis.

57. The method of claim 56, wherein said tagging data communicated by said network interface comprises:
tagging all data transmitted by a host system associated with said network interface with the same said preselected classification.

58. The method of claim 56, wherein said tagging said data comprises:
inserting a classification flag into a header block of a data packet associated with said data.

59. The method of claim 56, wherein said network node is disposed at a network edge.

60. The method of claim 56, further comprising:
monitoring communication bandwidth utilization associated with said network interface; and
decreasing communication of data associated with said network interface as a function of said monitored communication bandwidth utilization.

61. The method of claim 60, further comprising:
comparing said monitored communication bandwidth utilization to at least one data communication bandwidth threshold value.
